(19) United States
(12) Patent Application Publication
(10) Pub. No.: US 2007/0002214 A1
(43) Pub. Date: Jan. 4, 2007

(54) Liquid crystal device and method for manufacturing liquid crystal device

(76) Inventor: Takashi Sasabayashi, Kawasaki (JP)

Correspondence Address: GREER, BURNS & CRAIN, 300 S WACKER DR, 25TH FLOOR, CHICAGO, IL, 60606, US

(21) Appl. No.: 10/550,369

(22) PCT Filed: Mar. 22, 2004
(86) PCT No.: PCT/JP04/03819

§ 371 Date: Jul. 12, 2006

(30) Foreign Application Priority Data
Mar. 20, 2003 (JP) 2003-076704

(51) Int. Cl. G02F 1/1333; G02F 1/1337

(52) U.S. Cl. 349/88; 349/130; 349/117

(57) ABSTRACT

In a liquid crystal display device comprising a liquid crystal layer and a pair of electrodes for applying voltage onto the liquid crystal installed on both sides of the liquid crystal layer, the liquid crystal layer and pair of electrodes being sandwiched between a pair of substrates, the liquid crystal layer is made to have sections obtained by polymerizing a polymerizable compound in the presence of the liquid crystal through selective irradiation of active energy rays over the substrate surface with no voltage application, and sections obtained through polymerization by the selective irradiation of active energy rays, followed by irradiation of active energy rays all over the substrate surface with voltage application. Liquid crystal display devices excellent in high transmission, high-speed response, wide viewing angle properties, etc. are obtained.

### BACKGROUND OF THE INVENTION

1. Field of the Invention

The present invention relates to a liquid crystal display device which can realize high transmission, high-speed response, and a wide viewing angle.

2. Description of the Related Art

Recently, liquid crystal display devices have been widely used in various applications, taking advantage of features including flatness, light weight, low voltage driving and low electric power consumption. Furthermore, display characteristics which can compete with those of CRTs have been realized, and accordingly, liquid crystal display devices are used even for applications such as monitors and television sets for which CRTs have been mainly used conventionally.

Among the liquid crystal display devices which have been used in practice as having high display characteristics that can compete with those of CRTs, known are MVA (multi-domain vertical alignment) mode liquid crystal display devices. In the MVA mode liquid crystal display devices, the liquid crystal molecules are aligned vertically to the substrate surface when no voltage is applied, and when a voltage is applied, protrusions and depressions formed on a substrate surface, or slits installed in an electrode control the directions toward which the liquid crystal molecules tilt.

FIG. 1 illustrates an example of a patterned pixel electrode structure in an MVA mode liquid crystal display device. This pixel electrode is composed of a crisscross basic region 1 and four branch regions 2 that extend linearly to the 45°, 135°, 225° and 315° directions. The branch regions have an electrode width of about 3 μm, and a slit width of about 3 μm. The electrode on the counter substrate (not illustrated) is a uniform electrode as a whole.

When a voltage is applied to an electrode in which fine slits are formed as shown in FIG. 1, the liquid crystal molecules show a property of tilting along the directions of the slits. In the case of FIG. 1, when a voltage is applied, the liquid crystal molecules 4 in the near-basic region 3 start to tilt along the directions of the slits as illustrated, and the behavior of the liquid crystal molecules is propagated to the liquid crystal molecules in the branch regions, sequentially making them tilt along the directions of the slits. As a result, the liquid crystal layer forms a pattern according to the pattern given by the electrode which is outside of the liquid crystal layer, and the alignments in the four domains are realized in which the liquid crystal molecules tilt toward the four respective directions in the four branch regions.

However, when a voltage is applied, the behavior of the liquid crystal molecules in the near-basic region is propagated to the surrounding regions, and therefore, some time is needed for all the liquid crystal molecules to eventually tilt. In addition, if the branch regions are long, there are occasions, as shown in FIG. 1, in which liquid crystal molecules that should tilt toward the proper A direction actually tilt toward the B direction which is the reverse of the A direction, when they are in a branch part far away from the near-basic region. It is considered to be caused by the liquid crystal molecules tilting before the behavior of the liquid crystal molecules in the near-basic region is propagated to the surrounding regions. In this case, a bordering area is formed between A and B, and the bordering area does not transmit light even when a voltage is applied, and accordingly, cause the lowering of the transmittance.

As a means to solve the above-described problem, a method is proposed in which a liquid crystal layer is formed in an MVA mode liquid crystal display device by sealing a liquid crystal composition comprising a liquid crystal and a polymerizable compound in the device, and the compound is polymerized by irradiating active energy rays over the substrate surface, while a voltage is applied to the liquid crystal layer to regulate the alignment (see Japanese Unexamined Patent Application Publication No. H7-43689, claims, Japanese Unexamined Patent Application Publication No. H9-146068, claims, and Japanese Unexamined Patent Application Publication No. H10-147783, claims).

Taking, as an example, a case in which a liquid crystal composition comprising a liquid crystal and a polymerizable compound is sealed in an MVA mode liquid crystal display device having an electrode pattern as shown in FIG. 1, it is possible to prevent the liquid crystal molecules from tilting in the reverse directions as shown at B in FIG. 1, by gradually applying a voltage during the realization of the four domain alignments through voltage application as described above. Then, the compound is subjected to polymerization by irradiating active energy rays over the panel surface, in this state. Through this, the compound is polymerized, with the result that the tilting directions of the liquid crystal molecules are fixed in a state as a voltage is applied.

The liquid crystal display device thus prepared has the liquid crystal molecules having some tilts toward the directions to which the molecules are to tilt as against the vertical direction, even when no voltage is applied. Therefore, the response speed at the time of voltage application is improved, and a uniform and stable alignment status is realized. In addition, since in the liquid crystal display device of this mode, there is no need of forming protrusions or the like that cause the decrease in the transmittance, a liquid crystal display device with a high transmittance can be realized. That is, such an MVA mode liquid crystal display device can realize a high transmittance, high-speed response, and uniform and stable alignment status, compared with the conventional MVA mode liquid crystal display devices.

However, in this mode, it is necessary to introduce a patterned electrode in order to regulate the tilting directions of the liquid crystal molecules, which may result in fluctuation in qualities, complicated processings, decrease in production yield, and high costs. Particularly when fine slits as shown in FIG. 1 are installed, the transmittance fluctuates even by a slight fluctuation of the patterning. Accordingly, a very high precision is required in the production process.

### SUMMARY OF THE INVENTION

Accordingly, it is an object of the present invention to provide a liquid crystal display device excellent in high transmission, high-speed response, wide viewing angle, etc. It is also an object of the present invention to provide a method for manufacturing the liquid crystal display device. Other purposes and advantages of the present invention will be clarified in the following explanations.

According to one aspect of the present invention, provided is a liquid crystal display device comprising a liquid crystal layer and a pair of electrodes for applying voltage onto the liquid crystal installed on both sides of the liquid crystal layer, the liquid crystal layer and pair of electrodes being sandwiched by a pair of substrates, wherein: the liquid crystal layer has a section obtained by polymerizing a polymerizable compound in the presence of the liquid crystal through selective irradiation of active energy rays over the substrate surface. It is preferable that the liquid crystal layer has a section obtained by polymerizing a polymerizable compound in the presence of the liquid crystal through selective irradiation of active energy rays over the substrate surface without voltage application.

By the present invention, a liquid crystal display device excellent in high transmission, high-speed response, wide viewing angle, etc. can be obtained.

Also preferable are that the liquid crystal layer has a section obtained by polymerization through selective irradiation of active energy rays followed by irradiation of active energy rays all over the substrate surface with voltage application; that at least one of the two irradiations of active energy rays has been carried out along a direction tilted from the normal to the substrate surface; that the liquid crystal layer shows a specific light shielding pattern caused by the alignment of liquid crystal molecules when a voltage is applied after the irradiation or irradiations of active energy rays; that the specific light shielding pattern caused by the alignment of liquid crystal molecules comprises at least one pattern selected from the group consisting of a lattice pattern, a crisscross pattern, a pattern in the shape of stripes and a pattern in the shape of stripes with bends; that a section or sections (alignment direction controlling section or sections) that show an effect to control the alignment directions caused by a polymerized liquid crystal composition obtained by the selective irradiation of active energy rays are installed on either one or both of the surfaces which contact the liquid crystal layer (liquid crystal layer contacting surfaces); that at least one means selected from the group consisting of protrusions, depressions and a slit pattern in an electrode is installed on the surface or surfaces which contact the liquid crystal layer (liquid crystal layer contacting surface or surfaces); that the liquid crystal has a negative dielectric constant anisotropy, and is aligned in the direction vertical to the substrate surface when no voltage is applied after the irradiation or irradiations of active energy rays; and that a first polarizer and a second polarizer are installed each on one of the outer sides of the pair of substrates so that the absorption axes of the two polarizers are perpendicular to each other, a first ¼ wavelength plate is installed between one of the substrates and the first polarizer, a second ¼ wavelength plate is installed between the other one of the substrates and the second polarizer, and the absorption axis of the first polarizer is at 45° from the phase delay axis of the first ¼ wavelength plate, the absorption axis of the second polarizer is at 45° from the phase delay axis of the second ¼ wavelength plate, and the phase delay axis of the first ¼ wavelength plate and the phase delay axis of the second ¼ wavelength plate are perpendicular to each other.

According to another aspect of the present invention, provided is a method for manufacturing a liquid crystal display device comprising a liquid crystal layer and a pair of electrodes for applying voltage onto the liquid crystal installed on both sides of the liquid crystal layer, the liquid crystal layer and pair of electrodes being installed between a pair of substrates, the method comprising: forming the liquid crystal layer from a liquid crystal composition comprising a liquid crystal and a polymerizable compound; polymerizing part of the polymerizable compound by selective irradiation of active energy rays over the substrate surface with no voltage application; and then, polymerizing the polymerizable compound by irradiation of active energy rays all over the substrate surface with voltage application.

Preferable are that a photomask is used for the selective irradiation of active energy rays; that the light shielding section width and opening width of the photomask are each in the range of 2 to 100 μm; that the active energy rays are ultraviolet rays; that the irradiations of active energy rays are carried out so that the liquid crystal layer shows a specific light shielding pattern caused by the alignment of liquid crystal molecules when a voltage is applied after the irradiations of active energy rays; that at least one of the two irradiations of active energy rays is carried out along a direction tilted from the normal to the substrate surface; that the irradiation of active energy rays at no voltage application is carried out so that a section or sections (alignment direction controlling section or sections) that show an effect to control the alignment directions caused by a polymerized liquid crystal composition obtained by the selective irradiation of active energy rays are generated on either one or both of the surfaces which contact the liquid crystal layer (liquid crystal layer contacting surfaces); and that at least one means selected from the group consisting of protrusions, depressions and a slit pattern installed in an electrode is installed on the surface or surfaces which contact the liquid crystal layer (liquid crystal layer contacting surface or surfaces).

By the present invention, a simplified manufacturing process can be realized, and causes of fluctuation in qualities, complicated processings, decrease in production yield, and high costs in the conventional methods can be eliminated.

### BRIEF DESCRIPTION OF THE DRAWINGS

FIG. 1 is a schematic plan view illustrating an example of a patterned pixel electrode structure in an MVA mode liquid crystal display device;

FIG. 2A is a schematic view explaining an irradiation treatment of active energy rays;

FIG. 2B is another schematic view explaining an irradiation treatment of active energy rays;

FIG. 3A is a schematic plan view illustrating a photomask;

FIG. 3B is a schematic plan view illustrating areas of a polymerized liquid crystal composition that correspond to the openings of the photomask;

FIG. 3C is a schematic plan view illustrating an alignment state of liquid crystal molecules when allover irradiation of active energy rays is carried out;

FIG. 4A is a schematic plan view illustrating a photomask;

FIG. 4B is a schematic plan view illustrating an alignment state of a liquid crystal when voltage is applied on the liquid crystal in a liquid crystal display device that has been prepared;

FIG. 5 is a schematic plan view illustrating photomask patterns;

FIG. 6 is a schematic plan view illustrating another photomask pattern;

FIG. 7 is a schematic view illustrating how polarizers and ¼ wavelength plates are installed;

FIG. 8A is a schematic plan view illustrating a pixel structure in a liquid crystal display device used in an example according to the present invention;

FIG. 8B is a schematic plan view illustrating a photomask used in an example according to the present invention;

FIG. 8C is a schematic plan view illustrating how a liquid crystal display device is overlaid with a photomask;

FIG. 9A is another schematic plan view illustrating a pixel structure in a liquid crystal display device used in an example according to the present invention;

FIG. 9B is another schematic plan view illustrating a photomask used in an example according to the present invention;

FIG. 9C is another schematic plan view illustrating how a liquid crystal display device is overlaid with a photomask;

FIG. 10A is another schematic plan view illustrating a pixel structure in a liquid crystal display device used in an example according to the present invention;

FIG. 10B is another schematic plan view illustrating a photomask used in an example according to the present invention;

FIG. 10C is another schematic plan view illustrating how a liquid crystal display device is overlaid with a photomask;

FIG. 11A is a view illustrating a slit pattern with openings in the shape of stripes;

FIG. 11B is a view illustrating a slit pattern in the shape of stripes with bends;

FIG. 11C is a view illustrating a slit pattern with openings in the shape of stripes containing a finer slit pattern;

FIG. 11D is a view illustrating a slit pattern in the shape of stripes with bends containing a finer slit pattern;

FIG. 12A is a view explaining how to form sections to control the alignment directions (referred to alignment direction controlling sections hereafter);

FIG. 12B is another view explaining how to form alignment direction controlling sections;

FIG. 13 is another view explaining how to form alignment direction controlling sections;

FIG. 14 is another view explaining how to form alignment direction controlling sections;

FIG. 15 is another view explaining how to form alignment direction controlling sections;

FIG. 16A is another view explaining how to form alignment direction controlling sections;

FIG. 16B is another view explaining how to form alignment direction controlling sections;

FIG. 17A is another view explaining how to form alignment direction controlling sections; and

FIG. 17B is another view explaining how to form alignment direction controlling sections.

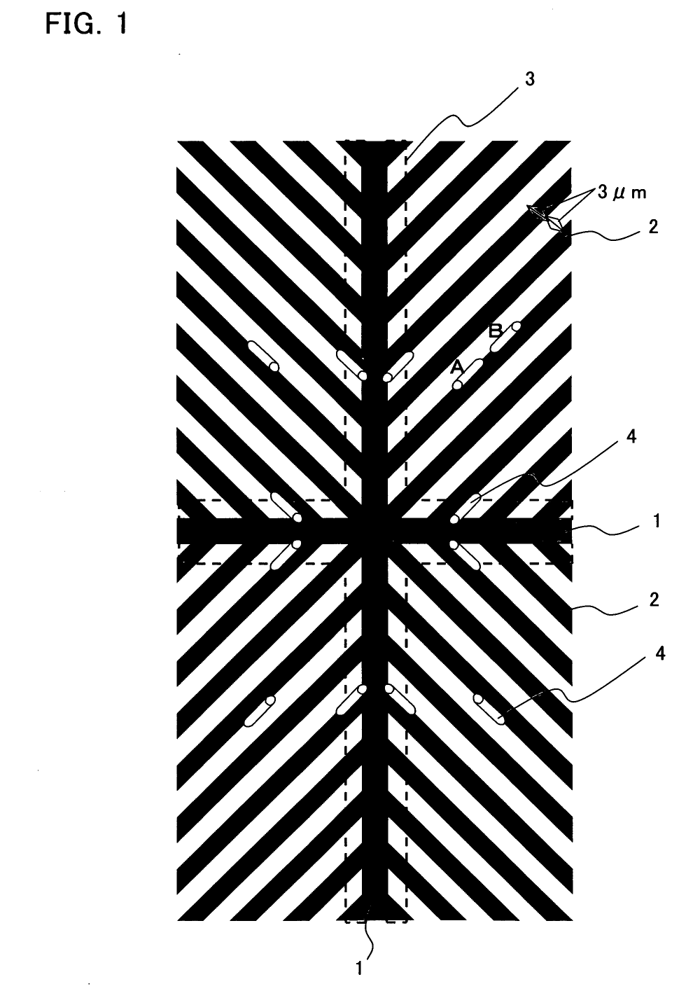

### DESCRIPTION OF THE PREFERRED EMBODIMENTS

Embodiments according to the present invention will be described with reference to the following figures, examples, etc. It is to be understood that these figures, examples, etc., plus the explanation below are for the purpose of illustrating the present invention, and do not limit the scope of the present invention. It goes without saying that other embodiments should also be included in the category of the present invention as long as they conform to the gist of the present invention. In the figures, the same sign indicates the same element.

A liquid crystal display device according to the present invention comprises a liquid crystal layer and a pair of electrodes for applying voltage onto the liquid crystal installed on both sides of the liquid crystal layer, the liquid crystal layer and pair of electrodes being sandwiched by a pair of substrates, wherein: the liquid crystal layer has a section obtained by polymerizing a polymerizable compound in the presence of the liquid crystal through selective irradiation of active energy rays over the substrate surface. In the following, this selective irradiation of active energy rays is called a selective active energy ray irradiation. It is convenient and reliable to use a so-called photomask in the selective active energy ray irradiation. It is to be noted that there is no particular limitation to the type of active energy rays for use. Ultraviolet rays are preferably used. In this case, other types of energy such as heat may be used together, as long as they do not contradict the gist of the present invention.

The liquid crystal layer before irradiating the substrate surface with active energy rays is composed of a composition (a liquid crystal composition) comprising a liquid crystal and a polymerizable compound, in which the liquid crystal and polymerizable compound are present together. However, when the polymerizable compound in the liquid layer is subjected to the selective polymerization as described above, sections which reflect the pattern of the light-exposed parts as the liquid crystal layer is seen in the direction vertical to the substrate surface, turn to be a polymerized liquid crystal composition, and the sections which reflect the pattern of the light-shielded parts remain as an unpolymerized liquid crystal composition.

It is preferable to carry out the selective active energy ray irradiation in a state of no voltage application. By this, the polymerizable compound in the liquid crystal composition that has been subjected to the selective active energy ray irradiation is crosslinked (cured) in a state in which the liquid crystal is vertically aligned, thus contributing to the eventual alignment and orientations in the liquid crystal layer. It was found that if such a pattern owing to the polymerized liquid crystal composition is present in the liquid crystal composition, the liquid crystal molecules tend to show alignment tilted to the directions along or regulated by the pattern when the unpolymerized liquid crystal composition are subjected to polymerization afterward.

Utilizing this makes it possible to regulate the directions of tilting of liquid crystal molecules in the areas outside of the pattern by the polymerized liquid crystal composition, even though known techniques such as patterning of an electrode, installation of uneven parts and rubbing of alignment control films are not employed. It is to be noted here that the patterning of an electrode, installation of uneven portions, rubbing of alignment control films, or the like may be carried out in combination with this.

It is possible to carry out the polymerization of the unpolymerized liquid crystal composition by irradiating active energy rays all over the substrate surface (overall active energy ray irradiation) with voltage application, after the selective active energy ray irradiation. The unpolymerized liquid crystal composition is thus polymerized, and the liquid crystal molecules show alignment as tilted in the directions along or regulated by the pattern of the polymerized liquid crystal composition.

There is no particular limitation to the polymerizable compound, as long as it is a polymerizable compound. It may be a so-called monomer or oligomer. This polymerization is often crosslinking polymerization, but other types of polymerization are also applicable. The polymerizable compound may be a mixture of a plurality of compounds. If catalysts and other additives are necessary, they can be used as constituents of the liquid crystal composition.

Whether the liquid crystal composition is polymerized, or whether a needed pattern is obtained may be determined by checking whether the liquid crystal molecules show alignment as tilted in the directions along or regulated by a specific pattern, when the unpolymerized liquid crystal composition is polymerized afterwards. The “whether the liquid crystal molecules show alignment as tilted in the directions along or regulated by a specific pattern” may be determined by checking whether the liquid crystal layer shows a specific light shielding pattern owing to the alignment of the liquid crystal, when a voltage is applied after the irradiations of active energy rays.

For example, in the case of a liquid crystal display device as one of preferred embodiments of the present invention having a structure wherein a first polarizer and a second polarizer are installed each on one of the outer sides of the pair of substrates so that the absorption axes of the two polarizers are perpendicular to each other, the liquid crystal layer has a liquid crystal having a negative dielectric constant anisotropy, and the liquid crystal is aligned in the direction vertical to the substrate surface when no voltage is applied, light does not transmit the liquid crystal display device owing to the second polarizer that shields the light which transmits the first polarizer, when no voltage is applied. This is because the liquid crystal is aligned vertically to the substrate surface. However, when a voltage is applied, birefringence occurs where the liquid crystal molecules are aligned as tilted in appropriate directions to the substrate surface, allowing transmittance of light.

In this occasion, in the areas that are polymerized by the overall active energy ray irradiation, the liquid crystal molecules show alignment as tilted in the directions along or regulated by the pattern owing to the above-described polymerized liquid crystal composition. Accordingly, if the pattern owing to the above-described polymerized liquid crystal composition is appropriate, the sections in which the liquid crystal molecules are aligned as tilted in the appropriate directions transmit light, while areas in which the tilting angles of the liquid crystal molecules are different from each other, are present in a random manner in the areas polymerized by the selective active energy ray irradiation, when there is no pattern present to be aligned along, and do not allow light transmission. In this way, a pattern that does not transmit light (a light shielding pattern in the liquid crystal layer owing to the alignment of the liquid crystal) occurs in the areas corresponding to the selective active energy ray irradiation and part of areas corresponding to the overall active energy ray irradiation.

The voltage application conditions for generating the a light shielding pattern in the liquid crystal layer owing to such alignment of a liquid crystal are determined by the factors whether the liquid crystal has a negative dielectric constant anisotropy or a positive dielectric constant anisotropy, whether the alignment control film is a vertical alignment control film or horizontal alignment control film, etc. For example, if the liquid crystal has a negative dielectric constant anisotropy, and the alignment control film is a vertical alignment control film, the light shielding pattern in the liquid crystal layer will occur by the alignment of the liquid crystal when a voltage is applied as described above. In this specification, for the purpose of simplification, the explanation will be made, unless otherwise noted, on the preferred cases in which the liquid crystal has a negative dielectric constant anisotropy, and is aligned in the direction vertical to the substrate surface by installing a vertical alignment control film or the like, when no voltage is applied.

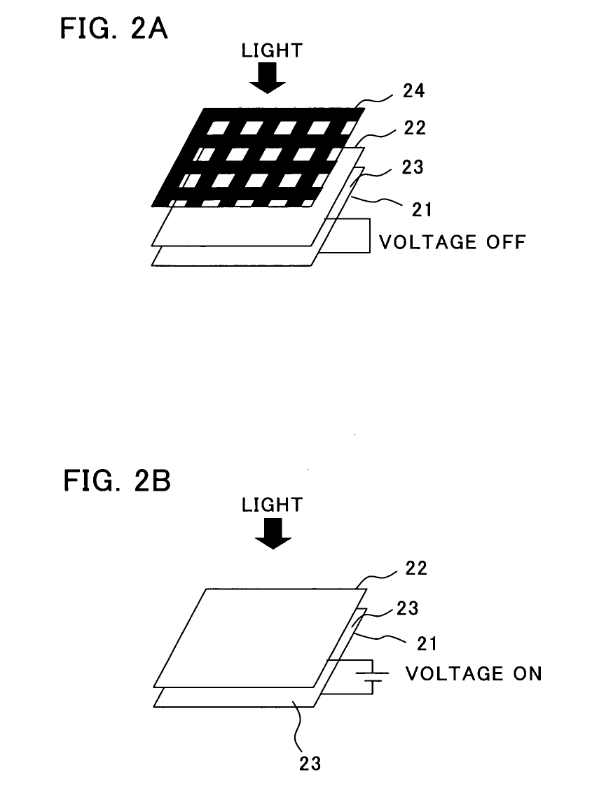

When a liquid crystal display device is prepared with a liquid crystal layer 23 and a pair of electrodes on both sides of the liquid crystal layer (not shown) installed between a pair of substrates 21, 22, such an active energy ray irradiation treatment can be carried out, as shown in FIG. 2 for example, by sealing a liquid crystal composition comprising a liquid crystal and a polymerizable compound between the substrates to form the liquid crystal layer; polymerizing part of the polymerizable compound by selective irradiation of active energy rays over the substrate surface with no voltage application; and then, polymerizing the polymerizable compound by irradiation of active energy rays all over the substrate surface with voltage application as shown in FIG. 2B.

By the present invention, causes for fluctuation in qualities, complicated processings, decrease in production yield, and high costs due to the electrode pattern having a fine width can be eliminated by such a simple manufacturing process.

Ultraviolet rays are convenient as the active energy rays, and are preferable. It is convenient and effective to carry out the selective active energy ray irradiation, for example, via a photomask 24.

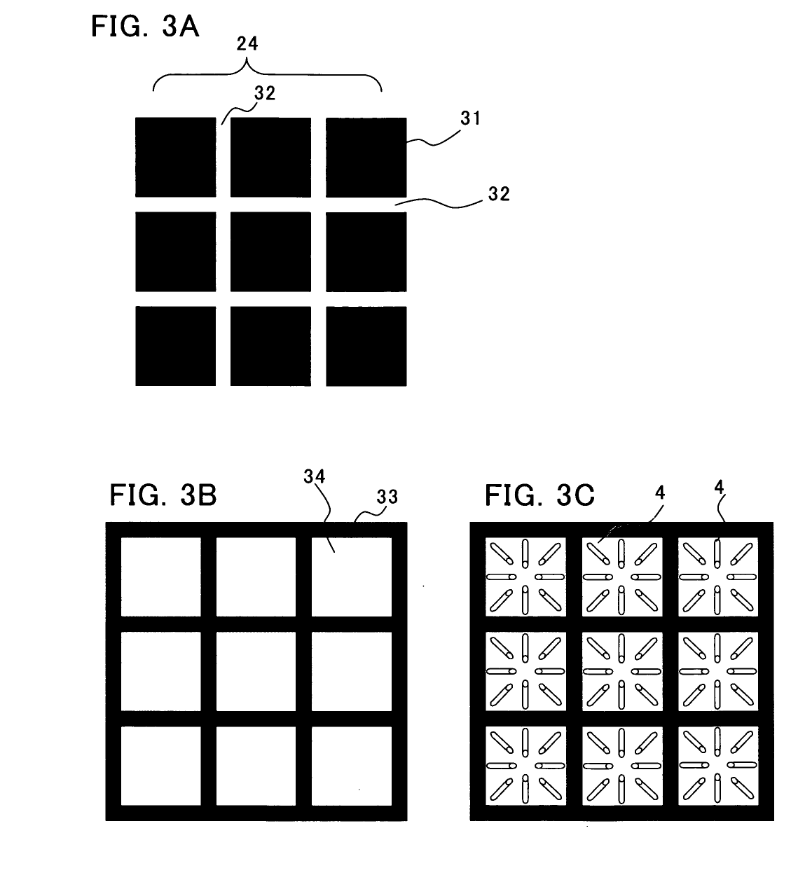

For example, active energy rays are irradiated selectively over the substrate surface through the photomask 24 having light shielding sections 31 and openings 32 as shown in FIG. 3A, in the state of no voltage applied onto the liquid crystal layer. In this state, the compound is polymerized in areas corresponding to the openings 32 of the photomask as shown in FIG. 3B, forming the polymerized liquid crystal composition areas 33.

Afterwards, when voltage is applied, the polymerized liquid crystal composition areas 33 gives a state in which the liquid crystal molecules are hard to tilt, compared with areas located under the light shielding sections of the photomask, that is, the unpolymerized liquid crystal composition areas 34. Furthermore, as shown in FIG. 3C, the liquid crystal molecules 4 in the areas where the compound is not polymerized become to tilt roughly symmetrical about the centers of the light shielding sections. The overall active energy ray irradiation is carried out in this state to polymerize the compound.

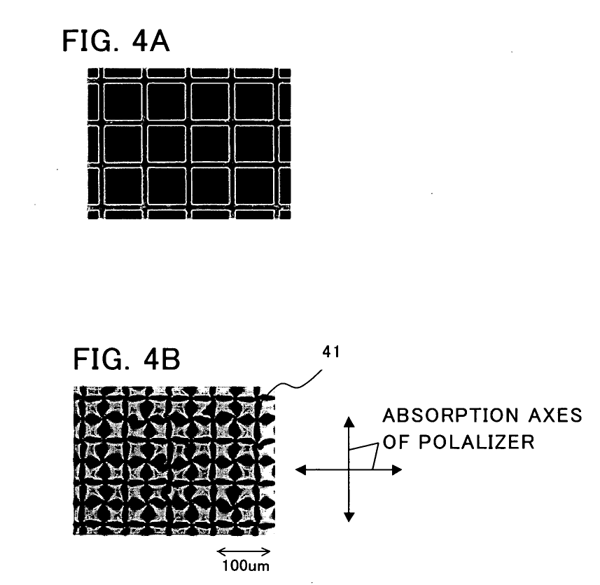

FIG. 4B shows a state of alignment when voltage was actually applied to the liquid crystal of a liquid crystal display device prepared according to the present invention, using the photomask shown in FIG. 4A. It is to be noted that the first and second polarizers were placed on either side of the liquid crystal display device respectively with their absorption axes perpendicular to each other. In FIG. 4B, the areas 41 that appear black correspond to the light shielding pattern in the liquid crystal layer owing to the alignment of the liquid crystal molecules that was described previously.

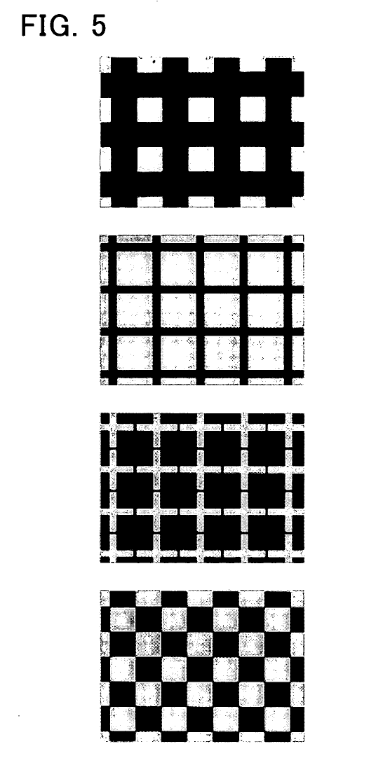

Various variations are possible as a photomask pattern, and can be appropriately selected depending on purposes. For example, preferable embodiments are masks having lattice patterns as shown in FIG. 5 which can result in light shielding patterns in the liquid crystal layers caused by the alignment of the liquid crystal molecules that are similar to the lattice patterns.

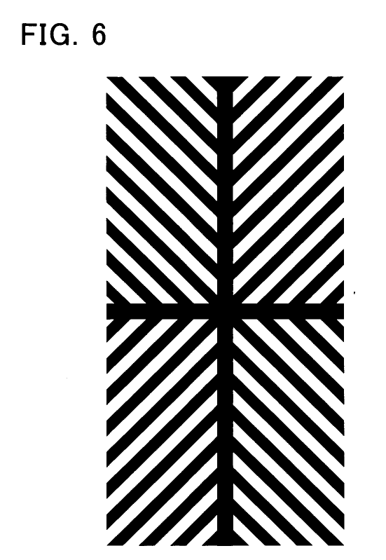

A mask is also a preferable embodiment which has been used as an electrode pattern in the conventional MVA mode liquid crystal display devices, and which has, as shown in FIG. 6, a fine slit pattern with a crisscross basic region and branch regions extending linearly to the peripheral directions so that it can make the light shielding pattern in the liquid crystal layer by the alignment of liquid crystal molecules contain a crisscross pattern. In FIGS. 5 and 6, the dark parts are the light shielding sections, and the light parts are the openings.

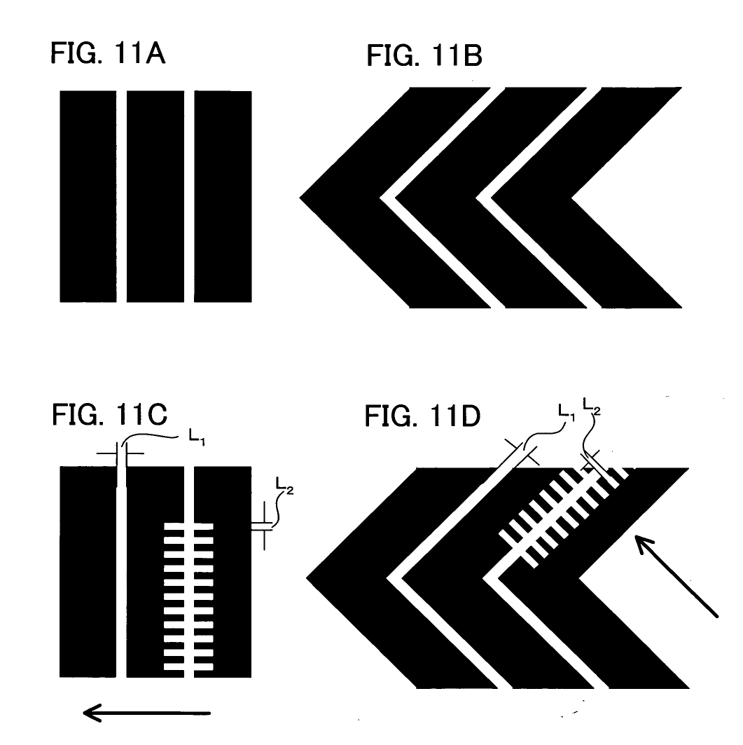

The directions of fine slits are not limited to those shown in FIGS. 5 and 6, and various modifications may be possible. For example, a slit pattern having openings in the shape of stripes as shown in FIG. 11A, and a slit pattern in the shape of stripes with bents as shown in FIG. 11B are applicable. Furthermore, patterns having finer slit patterns in a part or the whole of a slit pattern as shown in FIGS. 11C and 11D, are also applicable.

The tilting of the liquid crystal molecules by a pattern changes according to the width of the pattern. With a pattern width of not less than about 10 μm, the tilting occurs along the width direction, while with a pattern width of several μm or less, the tilting occurs along the longitudinal direction. Accordingly, when the width L₁ of the thicker slit pattern is set to, for example, 10 μm in the cases of FIGS. 11C and 11D, it can be easier to tilt the liquid crystal molecules along the directions of the arrows by installing a finer slit pattern, for example, with a width (L₂) of 3 μm. Those patterns that are the same as the slit patterns in an electrode often used as the patterns in the capacity of an alignment controlling means in the usual MVA mode liquid crystal display devices may be used as such patterns.

As described above, it is possible, by the present invention, to regulate the tilting directions of the liquid crystal molecules without forming, in the liquid crystal display device, an alignment controlling means such as protrusions, depressions, or slits in an electrode. It is to be noted, however, that it is possible to use alignment controlling means such as protrusions, depressions, and slits in an electrode, together with the techniques according to the present invention.

It was found that the polymerized liquid crystal composition produced by the selective active energy ray irradiation gives, on the liquid crystal layer contacting surfaces, sections that give effects similar to those of protrusions, depressions, or slits installed in an electrode. In this invention, a section that gives effects similar to those of protrusions, depressions, or a slit pattern installed in an electrode, is referred to as an alignment direction controlling section. Such an alignment direction controlling section can be formed on only either one of the two liquid crystal layer contacting surfaces as described later. Accordingly, it is possible to form an alignment direction controlling section on only either one of the two liquid crystal layer contacting surfaces, to form alignment direction controlling sections on both liquid crystal layer contacting surfaces, or combine the technique with protrusions, depressions, a slit pattern installed in an electrode, and/or the like.

It is to be noted that a liquid crystal layer contacting surface according to the present invention does not necessarily mean the surface of a simple substrate. It means the surface of a layer that the liquid crystal layer actually contacts. For example, when a substrate and a liquid crystal layer are layered with a filter layer in between, and the liquid crystal layer actually contacts the surface of the filter layer, but not the surface of the substrate, it means the surface of the filter layer that contacts the liquid crystal. If the surface of the filter is treated to provide hydrophilicity, it means the treated surface.

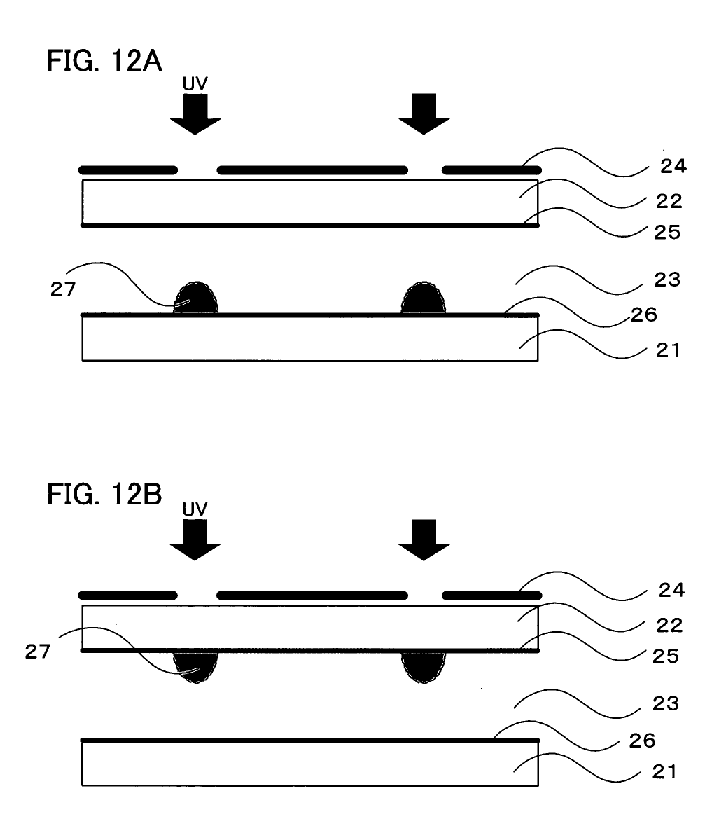

When light is irradiated through a photomask, whether an alignment direction controlling section 27 is formed on a liquid crystal layer contacting surface on the side to which the light is irradiated, or the opposite liquid crystal layer contacting surface, as shown in FIGS. 12A and 12B, are varied by the type and concentration of the polymerizable compound, presence or absence of a polymerization initiator, wavelength and intensity of the irradiated light, etc. In the figures, numeral 25 and 26 refer to the electrodes.

On which side of the two liquid crystal layer contacting surfaces an alignment direction controlling section or alignment direction controlling sections are present, can be known easily by checking whether the effect of the alignment direction controlling section(s) remains or not after the inside of the liquid crystal layer is washed, one of the liquid crystal layer contacting surfaces is substituted for a new part, and a new liquid crystal is put in. The effect of the alignment direction controlling section(s) often decreases to some extent, albeit present, after the reconstruction following the above-describe washing. It is considered that this is because some of the section(s) has been removed by the washing. It is not clear what shape the alignment direction controlling section(s) has. Accordingly, the parts indicated as alignment direction controlling sections shown in the following figures do not reflect the actual shape.

It is preferable to select the conditions for the above-described selective active energy ray irradiation so that the liquid crystal layer shows a specific light shielding pattern by the alignment of liquid crystal molecules as describe above when voltage is applied after the active energy ray irradiation treatments. The specific pattern may be selected appropriately depending on practices. Preferable light shielding patterns of a liquid crystal layer by the alignment of liquid crystal molecules are those containing lattice patterns or crisscross patterns, patterns in the shape of stripes, and patterns in the shape of stripes with bends. As the conditions of selective active energy ray irradiation for obtaining a light shielding pattern of a liquid crystal layer by such specific alignment of liquid crystal molecules, enumerated are type of the active energy rays, intensity of the active energy rays, irradiation angle of the active energy rays, duration of the active energy ray irradiation, shape of the pattern of a photomask, the location where a photomask is placed, etc.

When the active energy rays are ultraviolet rays, the intensity of the selective active energy ray irradiation is preferably in the range of 0.5 to 10 J/cm². The intensity of the overall active energy ray irradiation is preferably in the range of 2 to 40 J/cm². Thus, alignment towards specific tilted directions can be realized swiftly and precisely.

The width of the light shielding sections and width of openings of a photomask are preferably in the range of 2 to 100 μm, respectively. Thus, it becomes easier to realize alignment tilted in appropriate directions according to the present invention.

When active energy ray irradiation is carried out from a direction tilted to the normal of the substrate surface, liquid crystal molecules has a property to show tilting along the direction of the active energy ray irradiation. When the above-described active energy ray irradiation is carried out from a specific direction tilted to the normal of the substrate surface utilizing this, it is easier to regulate the tilting directions of the liquid crystal molecules, and accordingly sometimes preferable. The specific tilted directions may be arbitrarily set depending on practices. The active energy ray irradiation from the specific tilted direction may be applied to either of the selective active energy ray irradiation and the overall active energy ray irradiation.

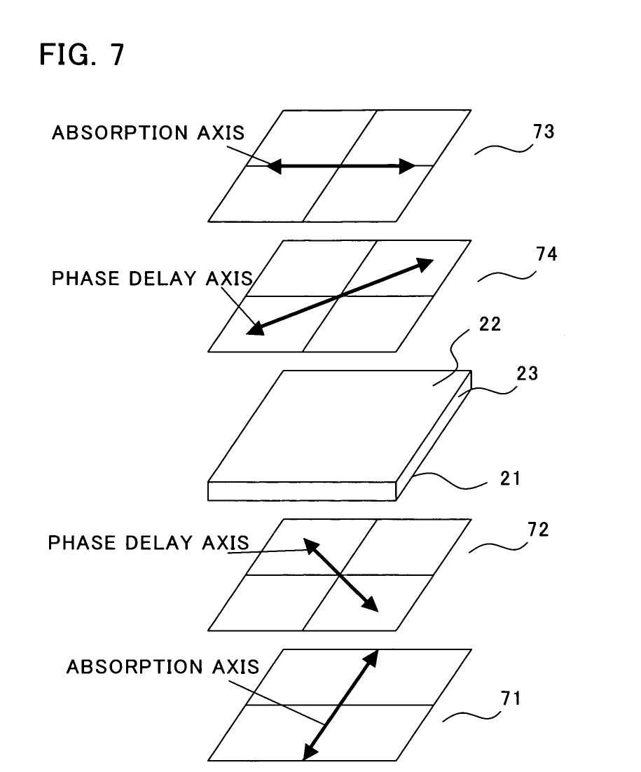

In an MVA mode liquid crystal display device, when liquid crystal molecules tilt in a direction at an angle other than 45° to the absorption axis of a polarizer, the areas do not transmit light and become a factor of decreasing the transmittance. When such areas showing a decreased transmittance appear by active energy ray irradiation from a specific titled direction or the like, the transmittance in the areas showing a decreased transmittance can be improved, as shown in FIG. 7, by installing a first ¼ wavelength plate 72 between one of the substrates 21 and a first polarizer 71; installing a second ¼ wavelength plate 74 between the other one of the substrates 22 and a second polarizer 73; making the absorption axis of the first polarizer 71 and the phase delay axis of the first ¼ wavelength plate 72 placed at 45° from each other; making the absorption axis of the second polarizer 73 and the phase delay axis of the second ¼ wavelength plate 74 placed at 45° from each other; and making the phase delay axis of the first ¼ wavelength plate 72 and the phase delay axis of the second ¼ wavelength plate 74 placed perpendicular to each other (Iwamoto, Togo, and Iimura, Preprints of Symposium on Japanese Liquid Crystal Society, 2000, PCa02, 2000), with the result that the transmittance can be improved as a whole. That is, by utilizing ¼ wavelength plates, it is possible to improve the transmittance of areas having a low transmittance such as shown in the dark portions in FIG. 4B.

In the case of the configuration shown in FIG. 7, when Iᵢₙ refers to an incident radiation intensity, Iₒᵤₜ refers to the intensity of transmitted light, and R_{LC} refers to a retardation of a liquid crystal layer, the following relationship holds. That is, the intensity of transmitted light is determined only by R_{LC} and not dependent on the tilting directions of liquid crystal molecules.
Iₒᵤₜ=½Iᵢₙ sin²(R_{LC}/2)

In this way, it is possible to improve the transmittance of areas having a low transmittance such as shown in FIG. 4B, by utilizing ¼ wavelength plates in the present invention.

There is no particular limitation to the polymerizable compound used for a liquid crystal composition according to the present invention, and any known polymerizable compound may be used that is used together with a liquid crystal in a liquid crystal display device. Crosslinking-polymerizable compounds are generally preferable. Diacrylate compounds are the examples.

There is no particular limitation also to the liquid crystal used for a liquid crystal composition according to the present invention, and any known liquid crystal may be used as long as it does not contradict the gist of the present invention. Nematic liquid crystals having a negative dielectric constant anisotropy are examples of a favorable liquid crystal, as has already been explained.

In the way described above, the liquid crystal display devices according to the present invention can realize high transmission, high-speed response, and wide viewing angle properties that are on the same level as or higher than those of liquid crystal display devices by the conventional technologies with patterning of an electrode, installation of uneven portions, rubbing of alignment control films, or the like.

Furthermore, according to the method for manufacturing a liquid crystal display device of the present invention, a simplified manufacturing process can be realized, and the factors for fluctuation in qualities, complicated processings, decrease in production yield, and high costs can be eliminated.

The liquid crystal display devices according to the present invention can be utilized, most typically, as liquid crystal display devices such as displays for personal computers and television receivers, by installing driving devices, etc. It goes without saying that they can be used for any other applications that need functions to control the way in which light is transmitted by the action of a liquid crystal. For example, liquid crystal shutters, liquid crystal projectors, photochromic glasses, and displays of mobile information terminals are enumerated.

It goes without saying that the present invention is similarly effective even when horizontal alignment control films are used, or when liquid crystals having a positive dielectric constant anisotropy are used.

The following are detailed explanations of embodiments according to the present invention.

### EXAMPLE 1

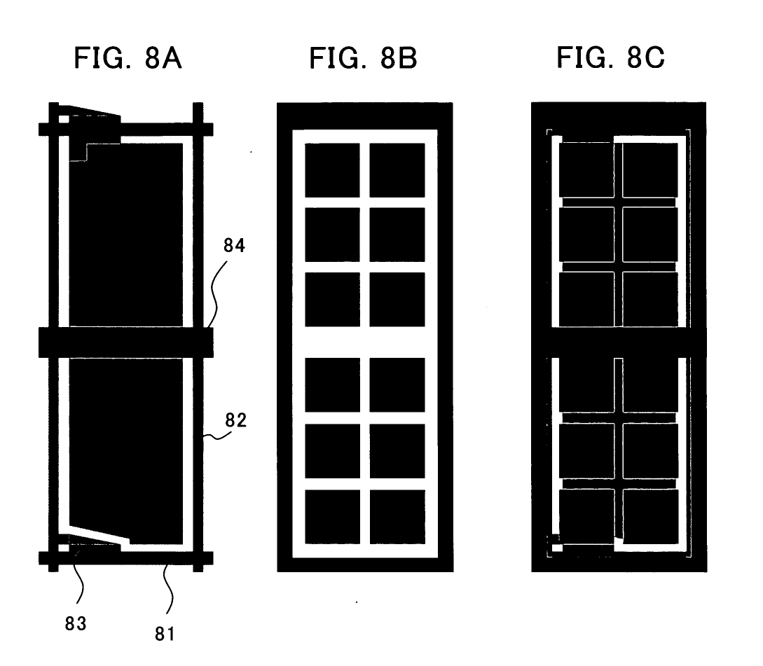

FIG. 8A is a plan view illustrating a pixel structure in a liquid crystal display device according to the present invention. Gate bus lines 81 and data bus lines 82 are formed in a matrix form, wherein a gate bus line 81 and a data bus line 82 are connected to a pixel electrode via a TFT element 83. In the central part of the pixel electrode, an auxiliary capacitor electrode 84 is formed. On the other substrate which is not illustrated, color filters, and a common electrode for all over the display area are formed (not illustrated).

First, vertical alignment control films were formed on both substrates. Patterning of an electrode, installation of uneven portions, and rubbing of the alignment control films were not performed.

Then, both substrates were stuck to each other with a spacer in between, and a liquid crystal composition obtained by mixing a nematic liquid crystal having a negative dielectric constant anisotropy and a diacrylate polymerizable compound at a concentration of 0.3 wt. % was sealed in the space to form a liquid crystal display device.

Then, a photomask shown in FIG. 8B was overlaid to the liquid crystal display device as shown in FIG. 8C, and 2 J/cm² of ultraviolet rays were selectively irradiated over the substrate surface through the photomask with no voltage application to the liquid crystal layer, to polymerize part of the polymerizable compound.

Afterwards, the photomask was removed, and 4 J/cm² of ultraviolet rays were irradiated all over the substrate surface with applying a voltage of 20 V to the liquid crystal layer so as to polymerize the polymerizable compound.

Polarizers having absorption axes perpendicular to each other were placed on both sides of the liquid crystal display device, one layer of a ¼ wavelength plate was placed between the liquid crystal display device and each polarizer, wherein the phase delay axis of a ¼ wavelength plate and the absorption axis of an adjacent polarizer were made to be at 45° from each other, and both phase delay axes of the ¼ wavelength plates were made to be perpendicular to each other.

### EXAMPLE 2

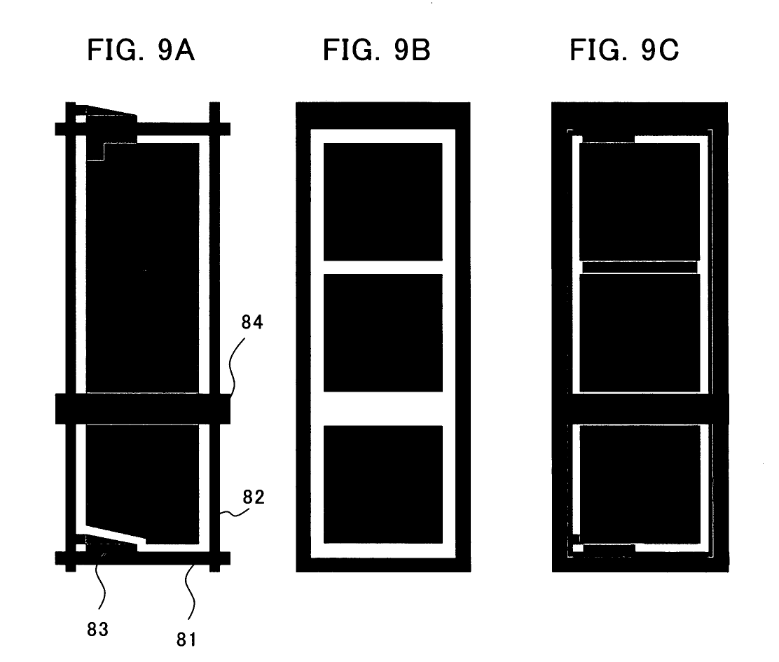

A liquid crystal display device was prepared in a similar manner as for EXAMPLE 1, except that the pixel structure shown in FIG. 9A was employed instead of the one shown in FIG. 8A, the photomask shown in FIG. 9B was employed instead of the one shown in FIG. 8B, and the layering as shown in FIG. 9C was employed instead of the one shown in FIG. 8C.

### EXAMPLE 3

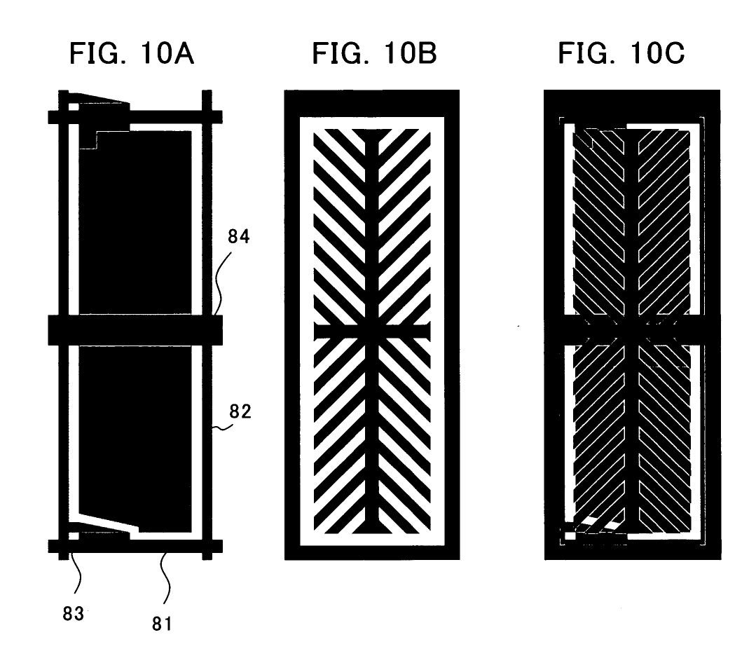

A liquid crystal display device was prepared in a similar manner as for EXAMPLE 1, except that the pixel structure shown in FIG. 10A was employed instead of the one shown in FIG. 8A, the photomask shown in FIG. 10B was employed instead of the one shown in FIG. 8B, and the layering as shown in FIG. 10C was employed instead of the one shown in FIG. 8C. The photomask shown in FIG. 10B had a light shielding section width of 3 μm and an opening width of 3 μm.

As a result of the above-describe examples, the leading edge response speed/trailing edge response speed at the switching between white color and black color were 20 milliseconds to compare with the conventional value of 25 milliseconds, the total wave transmittance was 1.3 time larger, and the wide viewing angle properties were the same or higher in all cases, when compared with the conventional MVA mode employing patterning of an electrode. That is, liquid crystal display devices were realized that had high transmission, high-speed response, and wide viewing angle properties on the same level as or higher than those of liquid crystal display devices by the conventional technologies with patterning of an electrode, installation of uneven portions, rubbing of alignment control films, or the like.

In the following EXAMPLEs 4 to 8, liquid crystal display devices having a pixel structure of the same constitution as in EXAMPLE 1 are formed. First, vertical alignment control films are installed on both substrates. Rubbing of alignment control films is not carried out. Both substrates are stuck to each other with a certain space held in between, and a liquid crystal composition obtained by mixing a nematic liquid crystal having a negative dielectric constant anisotropy and a diacrylate (a polymerizable compound) at a concentration of 0.3 wt. % is sealed in the space to form a liquid crystal display device. Afterwards, steps I and II, or I, II and III of each example are carried out.

It is to be noted that slit patterns are not formed in the electrodes in EXAMPLEs 4, 7 and 8. A slit pattern is formed in one of the electrodes in EXAMPLE 5. In the case of EXAMPLE 6, a protrusion pattern for alignment controlling is installed on one of the substrates.

### EXAMPLE 4

(Step I)

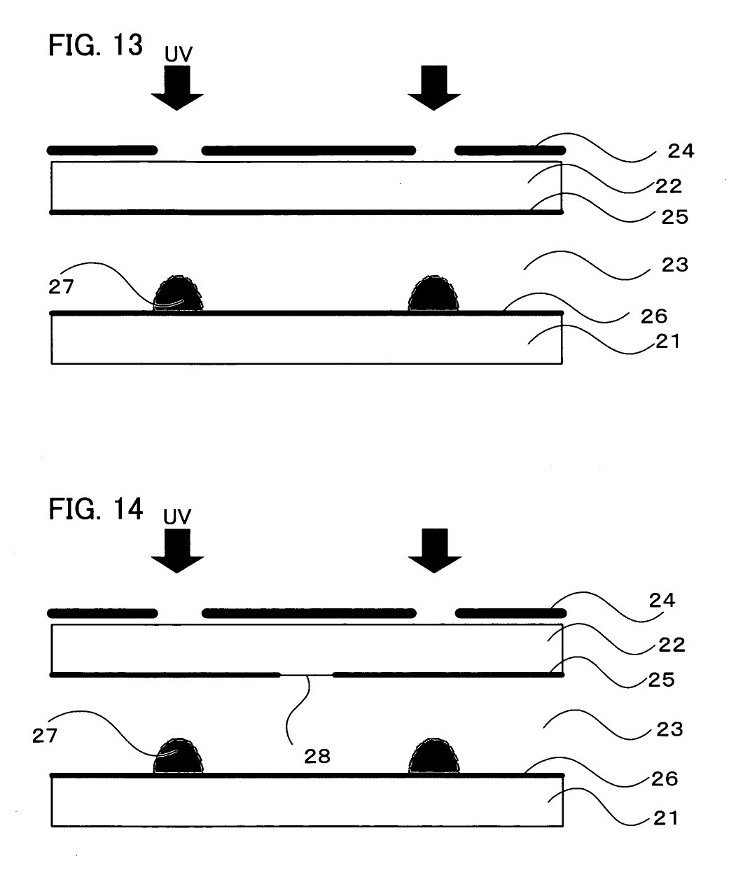

Two J/cm² of light having a wavelength of 365 nm is selectively irradiated over the surface of the liquid crystal display device through a photomask 24 with no voltage application to the liquid crystal layer, as shown in FIG. 13. Various patterns are applicable to the photomask as described above. In this case, alignment direction controlling sections 27 are formed at positions corresponding to the openings of the photomask 24 on the substrate (liquid layer contact surface to be exact) that is opposite to the side over which the light has been irradiated.

(Step II)

Four J/cm² of light having a wavelength of 365 nm is irradiated all over the liquid crystal display device surface with applying a voltage of 6 V to the liquid crystal layer.

Polarizers having absorption axes perpendicular to each other are placed on both sides of the liquid crystal display device, one layer of a ¼ wavelength plate is placed between the liquid crystal display device and each polarizer, wherein the phase delay axis of a ¼ wavelength plate and the absorption axis of an adjacent polarizer are made to be at 45° from each other, and both phase delay axes of the ¼ wavelength plates are made to be perpendicular to each other.

In this way, it becomes possible to control the alignment of the liquid crystal molecules by the alignment direction controlling sections.

### EXAMPLE 5

(Step I)

Two J/cm² of light having a wavelength of 365 nm is selectively irradiated, from the substrate side on which a silt pattern 28 is formed in the electrode, over the liquid crystal display device surface through the photomask 24 with no voltage application to the liquid crystal layer, as shown in FIG. 14. In this case, alignment direction controlling sections 27 are formed at positions corresponding to the openings of the photomask 24 on the substrate (liquid layer contact surface to be exact) that is opposite to the side over which the light has been irradiated.

(Step II)

Four J/cm² of light having a wavelength of 365 nm is irradiated all over the liquid crystal display device surface with applying a voltage of 6 V to the liquid crystal layer. Polarizers having absorption axes that are perpendicular to each other are placed on both sides of the liquid crystal display device.

In this way, it becomes possible to control the alignment of the liquid crystal molecules by the slit pattern previously formed in an electrode and the alignment direction controlling sections.

While various patterns are applicable as the slit pattern formed in an electrode and the photomask pattern as described above, it is more effective to have a configuration in which the slits formed in an electrode and the openings of the photomask appear alternately.

### EXAMPLE 6

(Step I)

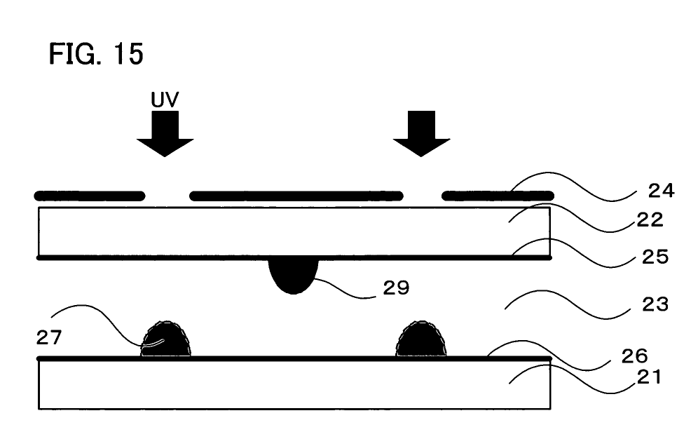

Two J/cm² of light having a wavelength of 365 nm is selectively irradiated, from the substrate side on which a pattern of protrusions 29 is formed, over the liquid crystal display device surface through the photomask 24 with no voltage application to the liquid crystal layer, as shown in FIG. 15. In this case, alignment direction controlling sections 27 are formed at positions corresponding to the openings of the photomask 24 on the substrate (liquid layer contact surface to be exact) that is opposite to the side over which the light has been irradiated.

(Step II)

Four J/cm² of light having a wavelength of 365 nm is irradiated all over the liquid crystal display device surface with applying a voltage of 6 V to the liquid crystal layer. Polarizers having absorption axes that are perpendicular to each other are placed on both sides of the liquid crystal display device.

In this way, it becomes possible to control the alignment of the liquid crystal molecules by the pattern of protrusions that have been previously installed and the alignment direction controlling sections.

While, as described above, various patterns are applicable as the pattern of protrusions that have been previously installed and the photomask pattern, it is more effective to have a configuration in which the protrusions of the protrusion pattern and the openings of the photomask appear alternately.

### EXAMPLE 7

(Step I)

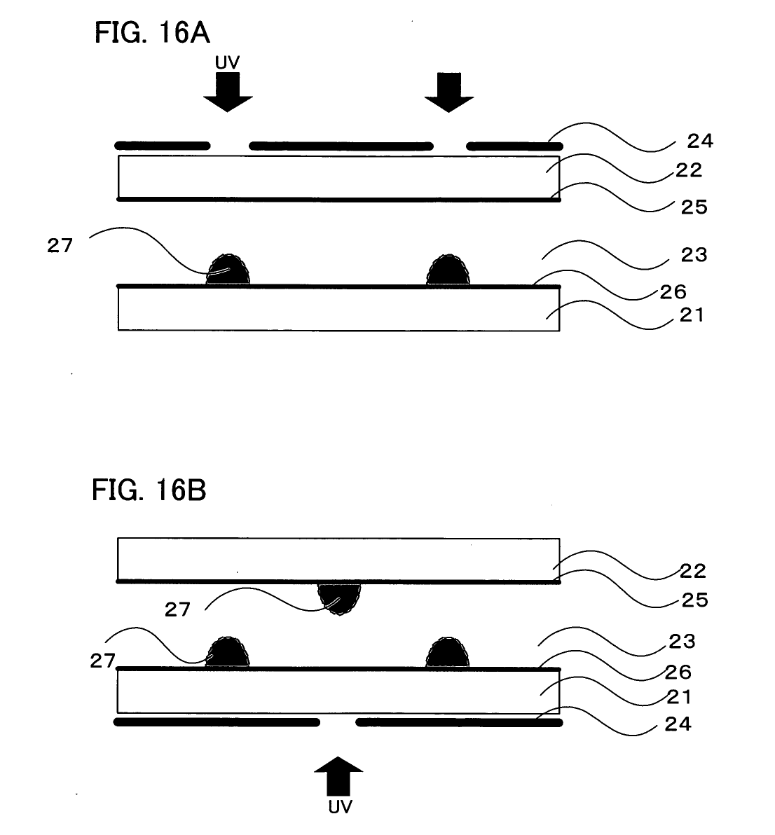

Two J/cm² of light having a wavelength of 365 nm is selectively irradiated over the liquid crystal display device surface through the photomask 24 with no voltage application to the liquid crystal layer, as shown in FIG. 16A. In this case, alignment direction controlling sections 27 are formed at positions corresponding to the openings of the photomask 24 on the substrate (liquid layer contact surface to be exact) that is opposite to the side over which the light has been irradiated.

(Step II)

Two J/cm² of light having a wavelength of 365 nm is selectively irradiated, from the side opposite to the side in step I, over the liquid crystal display device surface through the photomask 24 with no voltage application to the liquid crystal layer, as shown in FIG. 16B. In this case, alignment direction controlling sections 27 are formed at positions corresponding to the openings of the photomask 24 on the substrate (liquid layer contact surface to be exact) that is opposite to the side over which the light has been irradiated.

(Step III)

Four J/cm² of light having a wavelength of 365 nm is irradiated all over the liquid crystal display device surface with applying a voltage of 6 V to the liquid crystal layer. Polarizers having absorption axes that are perpendicular to each other are placed on both sides of the liquid crystal display device.

The alignment of the liquid crystal molecules is controlled by the alignment direction controlling sections formed in steps I and II. While various patterns are applicable as the photomask pattern used in steps I and II as described above, it is more effective to have a configuration in which each pattern appears alternately.

### EXAMPLE 8

(Step I)

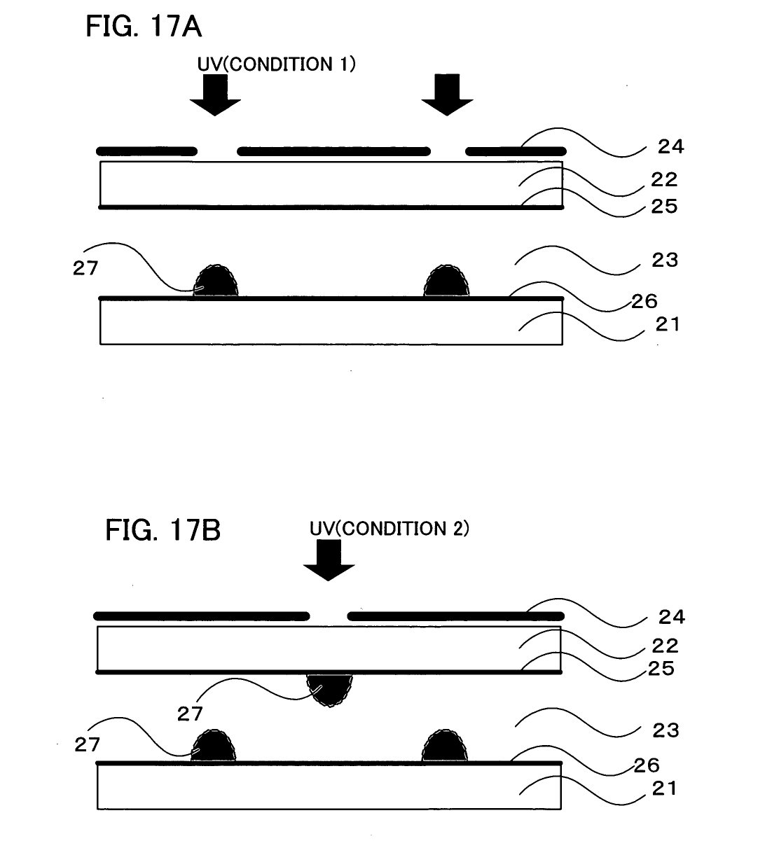

Two J/cm² of light having a wavelength of 365 nm is selectively irradiated over the liquid crystal display device surface through the photomask 24 with no voltage application to the liquid crystal layer, as shown in FIG. 17A (condition 1). In this case, alignment direction controlling sections 27 are formed at positions corresponding to the openings of the photomask 24 on the substrate (liquid layer contact surface to be exact) that is opposite to the side over which the light has been irradiated.

(Step II)

One J/cm² of light having a wavelength of 315 nm is selectively irradiated, from the same side as the side in step I, over the liquid crystal display device surface through the photomask 24 with no voltage application to the liquid crystal layer, as shown in FIG. 17B (condition 2). In this case, alignment direction controlling sections 27 are formed at positions corresponding to the openings of the photomask 24 on the substrate (liquid layer contact surface to be exact) over which the light has been irradiated.

(Step III)

Four J/cm² of light having a wavelength of 365 nm is irradiated all over the liquid crystal display device surface with applying a voltage of 6 V to the liquid crystal layer. Polarizers having absorption axes that are perpendicular to each other are placed on both sides of the liquid crystal display device.

It is possible to form alignment direction controlling sections 27 on different liquid layer contact surfaces by changing the light irradiation conditions in steps I and II. The alignment of the liquid crystal molecules is controlled by the alignment direction controlling sections 27 formed in steps I and II. While various patterns are applicable as the photomask pattern used in steps I and II as described above, it is more effective to have a configuration in which each pattern appears alternately.

In this way, liquid crystal display devices with high transmission, high-speed response, and wide viewing angle are realized.

1. A liquid crystal display device comprising a liquid crystal layer and a pair of electrodes for applying voltage onto the liquid crystal installed on both sides of said liquid crystal layer, the liquid crystal layer and pair of electrodes being sandwiched by a pair of substrates, wherein:
said liquid crystal layer has a section obtained by polymerizing a polymerizable compound in the presence of said liquid crystal through selective irradiation of active energy rays over the substrate surface.

2. A liquid crystal display device comprising a liquid crystal layer and a pair of electrodes for applying voltage onto the liquid crystal installed on both sides of said liquid crystal layer, the liquid crystal layer and pair of electrodes being sandwiched by a pair of substrates, wherein:
said liquid crystal layer has a section obtained by polymerizing a polymerizable compound in the presence of said liquid crystal through selective irradiation of active energy rays over the substrate surface without voltage application.

3. A liquid crystal display device according to claim 1 or 2, wherein said liquid crystal layer has a section obtained by polymerization through selective irradiation of active energy rays followed by irradiation of active energy rays all over the substrate surface with voltage application.

4. A liquid crystal display device according to claim 3, wherein at least one of said two irradiations of active energy rays has been carried out along a direction tilted from the normal to the substrate surface.

5. A liquid crystal display device according to one of claim 1 or 2, where said liquid crystal layer shows a specific light shielding pattern caused by the alignment of liquid crystal molecules when a voltage is applied after said irradiation or irradiations of active energy rays.

6. A liquid crystal display device according to claim 5, wherein said specific light shielding pattern caused by the alignment of liquid crystal molecules comprises at least one pattern selected from the group consisting of a lattice pattern, a crisscross pattern, a pattern in the shape of stripes and a pattern in the shape of stripes with bends.

7. A liquid crystal display device according to one of claim 1 or 2, wherein a section or sections (alignment direction controlling section or sections) that show an effect to control the alignment directions caused by a polymerized liquid crystal composition obtained by the selective irradiation of active energy rays are installed on either one or both of the surfaces which contact the liquid crystal layer (liquid crystal layer contacting surfaces).

8. A liquid crystal display device according to claim 7, wherein at least one means selected from the group consisting of protrusions, depressions and a slit pattern in an electrode is installed on the surface or surfaces which contact the liquid crystal layer (liquid crystal layer contacting surface or surfaces).

9. A liquid crystal display device according to one of claim 1 or 2, wherein said liquid crystal has a negative dielectric constant anisotropy, and is aligned in the direction vertical to the substrate surface when no voltage is applied after said irradiation or irradiations of active energy rays.

10. A liquid crystal display device according to one of claim 1 or 2, wherein:
a first polarizer and a second polarizer are installed each on one of the outer sides of said pair of substrates so that the absorption axes of the two polarizers are perpendicular to each other;
a first ¼ wavelength plate is installed between one of said substrates and the first polarizer;
a second ¼ wavelength plate is installed between the other one of said substrates and the second polarizer; and,
the absorption axis of the first polarizer is at 45° from the phase delay axis of the first ¼ wavelength plate, the absorption axis of the second polarizer is at 45° from the phase delay axis of the second ¼ wavelength plate, and the phase delay axis of the first ¼ wavelength plate and the phase delay axis of the second ¼ wavelength plate are perpendicular to each other.

11. A method for manufacturing a liquid crystal display device comprising a liquid crystal layer and a pair of electrodes for applying voltage onto the liquid crystal installed on both sides of said liquid crystal layer, the liquid crystal layer and pair of electrodes being installed between a pair of substrates, said method comprising:
forming said liquid crystal layer from a liquid crystal composition comprising a liquid crystal and a polymerizable compound;
polymerizing part of said polymerizable compound by selective irradiation of active energy rays over the substrate surface with no voltage application; and then,
polymerizing said polymerizable compound by irradiation of active energy rays all over the substrate surface with voltage application.

12. A method for manufacturing a liquid crystal display device according to claim 11, wherein a photomask is used for said selective irradiation of active energy rays.

13. A method for manufacturing a liquid crystal display device according to claim 12, wherein the light shielding section width and opening width of said photomask are each in the range of 2 to 100 mm.

14. A method for manufacturing a liquid crystal display device according to one of claims 11 to 13, wherein said active energy rays are ultraviolet rays.

15. A method for manufacturing a liquid crystal display device according to one of claims 11 to 13, wherein said irradiations of active energy rays are carried out so that said liquid crystal layer shows a specific light shielding pattern caused by the alignment of liquid crystal molecules when a voltage is applied after the irradiations of active energy rays.

16. A method for manufacturing a liquid crystal display device according to one of claims 11 to 13, wherein at least one of said two irradiations of active energy rays is carried out along a direction tilted from the normal to the substrate surface.

17. A method for manufacturing a liquid crystal display device according to one of claims 11 to 13, wherein said irradiation of active energy rays at no voltage application is carried out so that a section or sections (alignment direction controlling section or sections) that show an effect to control the alignment directions caused by a polymerized liquid crystal composition obtained by the selective irradiation of active energy rays are generated on either one or both of the surfaces which contact the liquid crystal layer (liquid crystal layer contacting surfaces).

18. A method for manufacturing a liquid crystal display device according to one of claims 11 to 13, wherein at least one means selected from the group consisting of protrusions, depressions and a slit pattern installed in an electrode is installed on the surface or surfaces which contact the liquid crystal layer (liquid crystal layer contacting surface or surfaces).
